(19) United States
(12) Patent Application Publication
(10) Pub. No.: US 2026/0153397 A1
(43) Pub. Date: Jun. 4, 2026

(54) HIGH-PRESSURE SENSOR WITH AN ALUMINUM OXIDE LAYER

(71) Applicant: Robert Bosch GmbH, Stuttgart (DE)

(72) Inventors: Soon Jung Jung, Sindelfingen (DE); Andrea Sonstroem, Reutlingen (DE); Armin Scharping, Metzingen (DE); Carsten Scholten, Stuttgart (DE); Carsten Kaschube, Nuertingen (DE); Gerhard Heusel, Reutlingen (DE); Marc Fischer, Ebersbach (DE); Marius Blideran, Tuebingen (DE); Thorsten Gross, Tuebingen (DE)

(21) Appl. No.: 19/392,541

(22) Filed: Nov. 18, 2025

(30) Foreign Application Priority Data
Dec. 2, 2024 (DE) 10 2024 211 490.1

(51) Int. Cl. G01L 9/00

(52) U.S. Cl. CPC G01L 9/008

(57) ABSTRACT

A high-pressure sensor. The high-pressure sensor includes: a substrate; a membrane, which is deflectable into a free region along a normal direction depending on an ambient pressure; measuring devices, which are applied above the membrane in the normal direction and each has at least one measuring device layer for electrically detecting the membrane deflection; and an insulating layer arranged at least on the membrane. A homogeneous aluminum oxide layer is arranged at least between the measuring device layer and the insulating layer.

### FIELD

The present invention relates to a high-pressure sensor.

### BACKGROUND INFORMATION

Germany Patent Application No. DE 10 2005 027 365 A1 describes a high-pressure sensor with a steel substrate, a membrane, an insulating layer and measuring devices made of a piezoresistive material, for example a NiCrSi alloy.

### SUMMARY

According to the present invention, a high-pressure sensor is provided. According to an example embodiment of the present invention, the high-pressure sensor includes: a substrate; a membrane, which is deflectable into a free region along a normal direction depending on an ambient pressure; measuring devices, which are applied above the membrane in the normal direction and each have at least one measuring device layer for electrically detecting the membrane deflection; an insulating layer arranged at least on the membrane; and a homogeneous aluminum oxide layer arranged at least between the measuring device layer and the insulating layer. Long-term drift of the sensor measurement signal of the high-pressure sensor can be reduced thereby. The aluminum oxide layer can reduce the influence of electrical charges distributed in the insulating layer on the measuring device layer and homogenize the charge distribution at the interface surface of the measuring device layer.

The charges can be generated by interface traps at the interface between the insulating layer and the adjacent layer and form energy levels within the band gap. The interface traps can arise from free bonds, impurities or structural defects in the material of the insulating layer. These interface traps can capture or release charge carriers, thereby creating electrical charges.

The aluminum oxide layer can reduce the interface traps, in particular by reducing free bonds and defects. It was found that this reduces the area density at interface traps to as low as 5.20×1010 cm-2eV-1 . Furthermore, this makes it possible to reduce the area density of the leakage current to 5.06×10-9 A/cm2. Thermodynamic stability can also be increased, thereby reducing the probability of chemical reactions or diffusions at the interface surface.

In the following, a top side and underside relate to the normal direction.

According to an example embodiment of the present invention, the high-pressure sensor can be configured to detect an ambient pressure starting at 10 bar. For example, an ambient pressure of more than 100 bar or more than 1000 bar can be measurable.

The membrane and/or the substrate can be made of metal, in particular stainless steel, or ceramic.

The free region can have a bridge structure below the membrane in the normal direction. The bridge structure allows the membrane to have a variable thickness at least in a lateral direction perpendicular to the normal direction. The bridge structure can be formed by a cylindrical free region in the substrate, thereby creating the membrane in one piece from the substrate.

Viewed in a plane having the normal direction as the normal, the membrane can be rectangular, oval, or round. The membrane can be made in one piece from the substrate.

The measuring devices can be spaced apart from one another. The measuring devices can be electrically connected to one another in a Wheatstone bridge circuit. The measuring devices can be arranged laterally overlapping the membrane edge where the membrane is attached to the substrate. The measuring devices can be electrically connected, in particular by wire bonding or flip-chip bonding.

The measuring device layer can be made of a piezoresistive and/or piezoelectric material. Depending on mechanical stresses acting upon it, the measuring device layer can cause a change in an electrical resistance or an electrical voltage.

The insulating layer can also be applied to the substrate. The insulating layer can be applied directly to the membrane and/or the substrate. The insulating layer can be arranged between the measuring device layer and the membrane.

The aluminum oxide layer can have a substantially constant layer thickness, i.e., a constant thickness is desired but is subject to tolerances due to the manufacturing process. An average layer thickness of the aluminum oxide layer can be greater than 5 nm, preferably greater than 20 nm and/or less than 100 nm. The aluminum oxide layer can be arranged directly on the insulating layer and/or directly below the measuring devices, in particular the measuring device layer. The aluminum oxide layer can be applied exclusively to the insulating layer on a top side of the substrate. The aluminum oxide layer can be applied directly to the substrate on at least one surface of the substrate other than the top side of the substrate, for example a side surface and/or an underside.

Above the measuring devices in the normal direction, a protective layer can be applied, in particular for electrical insulation and/or to protect the measuring devices from environmental influences.

In a preferred example embodiment of the present invention, it is advantageous if the aluminum oxide layer is made entirely of amorphous aluminum oxide. This allows the aluminum oxide layer to have evenly distributed charges. The aluminum oxide layer can have a disordered, irregular material structure. The aluminum oxide layer can exhibit isotropic electrical properties.

In a preferred example embodiment of the present invention, it is advantageous if the aluminum oxide layer is applied by atomic layer deposition. Atomic layer deposition (ALD) is a thin-film coating process that selectively deposits materials at the atomic level, making it possible to produce extremely thin, uniform and conformal layers.

In a preferred example embodiment of the present invention, the insulating layer is made of silicon oxide. The insulating layer can cover an entire top side of the substrate. The insulating layer can alternatively or additionally be made of silicon nitride or metal oxide. The insulating layer can be applied by chemical vapor deposition. The insulating layer can be applied by plasma-enhanced chemical vapor deposition (PECVD).

In a preferred example embodiment of the present invention, the aluminum oxide layer is arranged completely between the surface of the measuring devices and the insulating layer. The aluminum oxide layer can thus form at least the entire interface surface on an underside of the measuring devices.

In a preferred example embodiment of the present invention, the aluminum oxide layer is applied over a continuous area above the insulating layer in the normal direction.

In a particular example embodiment of the present invention, it is advantageous if the aluminum oxide layer covers at least the entire top side of the insulating layer.

In an advantageous example embodiment of the present invention, the aluminum oxide layer is arranged at least on a side wall of the substrate. However, the aluminum oxide layer can also be arranged exclusively above the membrane and/or the top side of the substrate. The aluminum oxide layer can be arranged on all side walls. The aluminum oxide layer can also be arranged on an underside of the substrate. The aluminum oxide layer can be applied directly to the substrate on at least one of the side walls and/or the underside of the substrate.

In a particular example embodiment of the present invention, it is advantageous if the aluminum oxide layer surrounds at least a main part of the envelope of the substrate. The aluminum oxide layer can surround the entire envelope of the substrate.

In a specific example embodiment of the present invention, it is advantageous if the measuring device layer is made of a nickel-chromium-silicon alloy. The measuring devices can have only one measuring device layer.

Further advantages and advantageous embodiments of the present invention can be found in the description of the figures and in the figures.

### BRIEF DESCRIPTION OF THE DRAWINGS

The present invention is described in detail below with reference to the figures.

FIG. 1 is a cross section of a high-pressure sensor in a specific example embodiment of the present invention.

FIG. 2 is a curve of a sensor measurement signal of a high-pressure sensor over time in a further specific example embodiment of the present invention.

### DETAILED DESCRIPTION OF EXAMPLE EMBODIMENTS

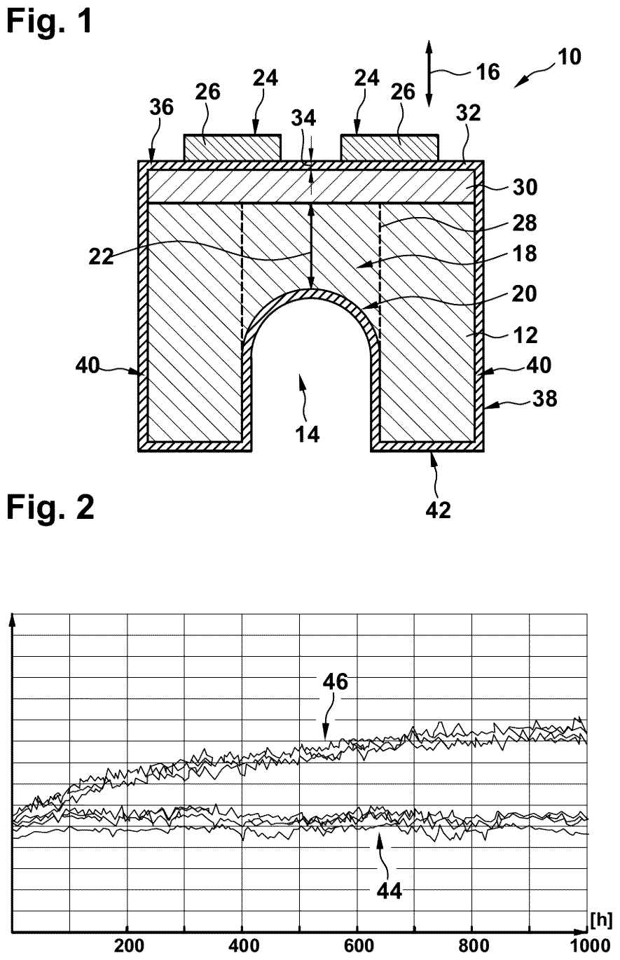

FIG. 1 shows a cross section of a high-pressure sensor in a specific embodiment of the invention. The high-pressure sensor 10 comprises a substrate 12, for example made of metal, and a membrane 18, which is deflectable into a free region 14 of the substrate 12 along a normal direction 16 depending on an ambient pressure and which is formed in one piece in the substrate 12. The free region 14 has a bridge structure 20 below the membrane 18 in the normal direction 16, and the membrane 18 has, thanks to the bridge structure 20, a variable membrane thickness 22 in a lateral direction perpendicular to the normal direction 16.

Multiple measuring devices 24 are attached spaced apart from one another above the membrane 18 in the normal direction 16. The measuring devices 24, which are in particular piezoresistive, each comprise a measuring device layer 26 for electrically detecting the membrane deflection. The measuring device layer 26 is made in particular of a nickel-chromium-silicon alloy. The measuring devices 24 are arranged in particular laterally overlapping the membrane edge 28 where the membrane 18 is attached to the substrate 12.

Furthermore, the high-pressure sensor 10 comprises an insulating layer 30, in particular made of silicon oxide, arranged between the measuring device layer 26 and the membrane 18. The insulating layer 30 covers the entire top side of the substrate 12 and is arranged directly on the substrate 12.

A preferably amorphous, homogeneous aluminum oxide layer 32 is arranged at least between the measuring device layer 26 and the insulating layer 30. The aluminum oxide layer 32 is applied in particular by atomic layer deposition and can have a substantially constant layer thickness 34, i.e., a constant thickness is desired but is subject to tolerances due to the manufacturing process.

The aluminum oxide layer 32 is arranged completely between the surface of the measuring devices 24 and the insulating layer 30 and is applied in particular over a continuous area above the insulating layer 30 in the normal direction 16. The aluminum oxide layer 32 covers the entire top side 36 of the insulating layer 30 and can even surround the entire envelope 38 of the substrate 12, including the side walls 40 and an underside 42 of the substrate 12.

FIG. 2 shows a curve of a sensor measurement signal of a high-pressure sensor over time in a further specific embodiment of the invention. The curve over time of multiple measured sensor measurement signals 44 of the high-pressure sensor is shown in comparison with multiple measured sensor measurement signals 46 of a high-pressure sensor according to the related art. It can be seen that the sensor measurement signals 44 drift less than the sensor measurement signals 46 and are therefore more stable over time.

1-10. (canceled)

11. A high-pressure sensor, comprising:
a substrate;
a membrane, which is deflectable into a free region along a normal direction depending on an ambient pressure;
measuring devices, which are applied above the membrane in the normal direction, and have at least one measuring device layer for electrically detecting the membrane deflection;
an insulating layer arranged at least on the membrane; and
a homogeneous aluminum oxide layer arranged at least between the at least one measuring device layer and the insulating layer.

12. The high-pressure sensor according to claim 11, wherein the aluminum oxide layer is made entirely of amorphous aluminum oxide.

13. The high-pressure sensor according to claim 11, wherein the aluminum oxide layer is applied by atomic layer deposition.

14. The high-pressure sensor according to claim 11, wherein the insulating layer is made of silicon oxide.

15. The high-pressure sensor according to claim 11, wherein the aluminum oxide layer is arranged completely between a surface of the measuring devices and the insulating layer.

16. The high-pressure sensor according to claim 11, wherein the aluminum oxide layer is applied over a continuous area above the insulating layer in the normal direction.

17. The high-pressure sensor according to claim 11, wherein the aluminum oxide layer covers at least the entire top side of the insulating layer.

18. The high-pressure sensor according to claim 11, wherein the aluminum oxide layer is arranged at least on a side wall of the substrate.

19. The high-pressure sensor according to claim 11, wherein the aluminum oxide layer surrounds at least a main part of an envelope of the substrate.

20. The high-pressure sensor according to claim 11, wherein the measuring device layer is made of a nickel-chromium-silicon alloy.
